(19) United States
(12) Patent Application Publication
(10) Pub. No.: US 2020/0355200 A1
(43) Pub. Date: Nov. 12, 2020

(54) TURBO MACHINE

(71) Applicant: MAN Energy Solutions SE, Augsburg (DE)

(72) Inventors: Oswald Lôwlein, Neu-Ulm (DE); Matthias Strauss, Schrobenhausen (DE); Sebastian Spengler, Wehringen (DE); Boris Thaser, Augsburg (DE); Frank Griesshaber, Augsburg (DE)

(21) Appl. No.: 16/867,781

(22) Filed: May 6, 2020

(30) Foreign Application Priority Data
May 9, 2019 (DE) 10 2019 112 055.1

(51) Int. Cl. F04D 29/42; F01D 25/24

(52) U.S. Cl. CPC F04D 29/4206; F05B 2240/14; F05B 2220/40; F01D 25/243

(57) ABSTRACT

A turbo machine, having a housing and, an impeller received in the housing. The housing has at least two housing parts connected to one another via a flange connection. A first housing part of the housing parts has threaded bores for connecting screws. A second housing part of the housing parts connected to one another has through-bores for the connecting screws. The second housing part lies against the first housing part with a first face and screw heads of the connecting screws lie against an opposite second face of the second housing part. The through-bores of the second housing part on and adjacent to the second face have a smaller cross-sectional area than on and adjacent to the first face.

### BACKGROUND OF INVENTION

### 1. Field of the Invention

The invention relates to a turbo machine.

### 2. Description of Related Art

The fundamental construction of a turbocharger is known to the person skilled in the art addressed here. A turbocharger comprises a turbine, in which a first medium is expanded and a compressor in which a second medium is compressed, namely utilising the energy extracted in the turbine during the expansion of the first medium.

The turbine of the turbocharger comprises a turbine housing and a turbine rotor. The compressor of the turbocharger comprises a compressor housing and a compressor rotor. Between the turbine housing of the turbine and the compressor housing of the compressor a bearing housing is positioned, wherein the bearing housing is connected on the one side to the turbine housing and on the other side to the compressor housing. In the bearing housing a shaft is mounted via which the turbine rotor is coupled to the compressor rotor.

The turbine housing of the turbine, the compressor housing of the compressor, and/or the bearing housing can each consist of multiple housing parts connected to one another by way of a flange connection. Likewise, the turbine housing can be connected to the bearing housing and the compressor housing to the bearing housing via flange connections, each of which then form housing parts of the turbocharger.

During the operation of the turbocharger there is a risk that the compressor rotor or the turbine rotor breaks and fragments of the broken rotor strike through the respective housing thus entering the surroundings. This has to be avoided for safety reasons.

### SUMMARY OF THE INVENTION

There is therefore a need for a turbo machine in which housing parts of a housing are connected to one another so that there is no risk that the respective flange connection fails and fragments of the rotor enter the surroundings.

This is not only a requirement for the turbocharger but also for other turbo machines such as compressors, gas turbines, blowers of exhaust gas recirculation devices, and the likes.

Starting out from this, one aspect of the invention is based on creating a new type of turbo machine. According to one aspect of the invention, the through-bores of the second housing part on and adjacent to the second face have a smaller cross-sectional area than on and adjacent to the first face.

In particular when, in the event of a failure, a fragment of a rotor strikes one of the housing parts that are connected to one another via the flange connection and as a consequence of the kinetic energy of the fragment of the rotor the housing parts that are connected to one another via the flange connection are moved or displaced relative to one another, the risk that the connecting screws of the flange connection fail for example as a consequence of a bending and/or shearing stress. Accordingly, a secure connection of housing parts connected to one another via flange connection is thus also ensured in the event of a failure as a result of which the so-called containment safety of the turbo machine is improved.

According to a first advantageous development, the cross-sectional area of the through-bores of the second housing part increases in size continuously from the second face in the direction of the first face at least in sections, in particular funnel-like or truncated cone-like. According to a second advantageous further development, the cross-sectional area of the through-bores of the second housing parts increases step-like in size starting out from the second face in the direction of the first face. With both advantageous further developments, the containment safety of the turbo machine can be increased. It is possible to combine these two advantageous further developments with one another namely in such a manner that in a first region the cross-sectional area of the through-bores increases in size continuously and in a second region the cross-sectional area of the through-bores increases step-like in the direction of the first face of the second housing part.

On and adjacent to the second face, the through-bores of the second housing parts have a circular cross-sectional area. On and adjacent to the first face, the through-bores have a circular or oval or elongated hole-like cross-sectional area. These features also serve for increasing the containment safety of the turbo machine.

Portions of the through-bores of the second housing part on and adjacent to the second face run centrically or eccentrically to portions of the through-bores of the second housing part on and adjacent to the first face. The containment safety of the turbo machine can also be increased by way of this.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1 is an extract from a turbo machine according to the prior art in the region of a flange connection;

FIGS. 2A and 2B are an extract from a turbo machine according to the invention in the region of a flange connection;

FIGS. 3A and 3B are an extract from a turbo machine according to the invention in the region of a flange connection;

FIGS. 4A and 4B are an extract from a turbo machine according to the invention in the region of a flange connection; and

FIGS. 5A and 5B are an extract from a turbo machine according to the invention in the region of a flange connection.

### DETAILED DESCRIPTION OF THE PRESENTLY PREFERRED EMBODIMENTS

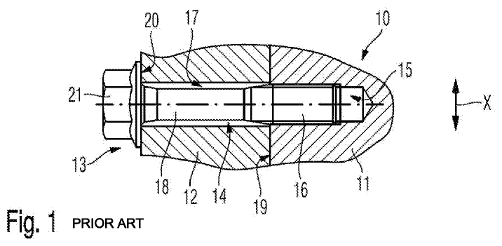

FIG. 1 shows an extract from a turbo machine according to the prior art in the region of a housing 10, namely in the region of two housing parts 11, 12 connected to one another. The two housing parts 11, 12 are connected to one another via a flange connection 13 that comprises multiple connecting screws 14. According to the prior art, the first housing part 11 of the housing parts 11, 12 connected to one another via the flange connection 13 comprises threaded bores 15, which interact with a threaded portion 16 of the respective connecting screw 14. A second housing part 12 of the housing parts 11, 12 connected to one another via the flange connection 13 comprises through-bores 17 for the connecting screws 14, wherein threadless portions 18 of the connecting screws 14 extend through these through-bores 17.

The second housing part 12, which comprises the through-bores 17 for the connecting screws 14, lies with a first face 19 against the first component 11. The connecting screws 14 with screw hats 21 lie against an opposite second face 20 of the second component 12.

In particular when for example in the event of a failure of a rotor (not shown) of the turbo machine a fragment of the rotor strikes one of the housing parts 11, 12 connected to one another via the flange connection 13 and as a consequence of the kinetic energy of the fragment a relative movement is caused between the housing parts 11, 12 connected to one another in particular in the direction of the arrow X shown in FIG. 1, the connecting screws 14 of the flange connection 13 are subjected to a bending and shear stress as a result of which there is the risk that the connecting screws 14 shear off and thus fail. In this case, fragments can then enter the surroundings but which because of safety region has to be avoided.

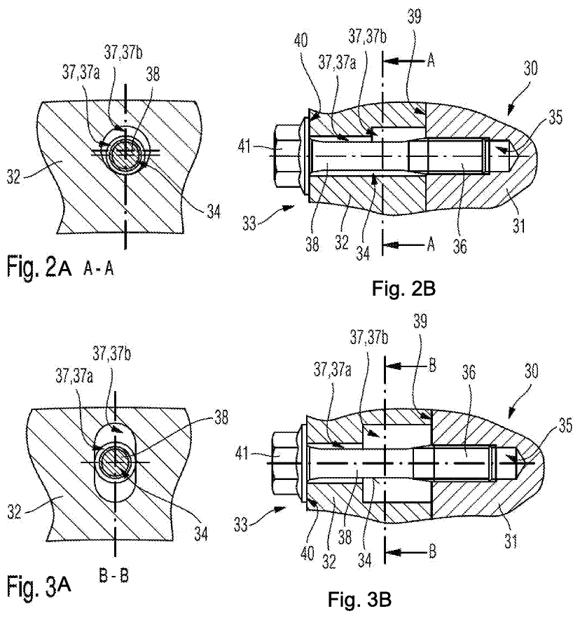

FIGS. 2A and 2B shows an extract from a first turbo machine according to one aspect of the invention in the region of a housing 30, wherein the housing 30 comprises the housing parts 31 and 32, which are connected to one another via a flange connection 33. Here, the flange connection 33 comprises multiple connecting screws 34. A first housing part 31 of the housing parts 31, 32 connected to one another via the flange connection 33 in turn comprises threaded bores 35 for the connecting screws 34. Thread portions 36 of the connecting screws 34 extend into the threaded bores 35 or are in engagement with the same. A second housing part 32 of the housing parts 31, 32 connected to one another via the flange connection 33 in turn comprises through-bores 37 for the connecting screws 34, wherein threadless portions 38 of the connecting screws 34 extend through these through-bores 37.

The second housing part 32 with the through-bores 37 in turn lies against the first component 31 with a first face 39, wherein the connecting screws 34 with their screw heads 41 lie against an opposite second face 40 of the second component 32.

In the turbo machine according to one aspect of the invention, the through-bores 37 of the second housing part 32 on and adjacent to the second face 40 have a smaller cross-sectional area than on and adjacent to the first face 39. Here, it is provided in the exemplary embodiment of FIGS. 2A and 2B that the cross-sectional area of the through-bores 37 of the second housing part 32, emanating from the second face 40 increases in size step-like in the direction of the first face 39 so that in FIGS. 2A and 2B accordingly two portions 37a, 37b of the through-bore 37 are formed with different cross-sectional areas that are however constant over their portion length. Here, the two portions 37a, 37b of the through-bore 37 each have a circular cross-sectional area, i.e. both on and adjacent to the first face 39 and on and adjacent to the second face 40. Here, these two portions 37a, 37b of the through-bore 37 that are circular in the cross section are positioned eccentrically to one another, so that longitudinal center axes of the portions 37a, 37b of the through-bores 37 accordingly do not lie on top of one another, but are offset parallel to one another.

Through the above configuration of the through-bores 37, a larger cross-sectional area is provided in the interface region between the two components 31, 32 connected to one another via the flange connection 33 and thus via the connecting screws 34, which allows a greater relative movement of the two components 31, 32 connected to one another relative to one another, as a result of which the risk of a shearing-off and thus a failure of the connecting screws 34 is reduced. In the region of the second face 40 of the second component 32 of the components 31, 32 connected to one another via the flange connection 33 however an adequately large contact face for the screw heads 41 is provided.

Deviating from the exemplary embodiment shown in FIGS. 2A and 2B with the two portions 37a, 37b of the through-bores 37 that are circular in the cross section, which are orientated eccentrically to one another, it is also possible that the two portions 37a, 37b with the cross-sectional areas that are circular in the cross section are positioned centrically to one another.

FIGS. 3A and 3B shows an extract from a turbo machine according to one aspect of the invention in the region of a housing 30, namely in the region of two connected housing parts 31, 32, which in turn are connected to one another via a flange connection 33. To avoid unnecessary repetitions, same reference numbers are used in the exemplary embodiment of FIGS. 2A and 2B as for the exemplary embodiment of FIGS. 3A and 3B, wherein in the following only such details are discussed, by way of which the exemplary embodiment of FIGS. 3A and 3B differs from the exemplary embodiment of FIGS. 2A and 2B. With respect to all remaining details, the exemplary embodiment of FIGS. 3A and 3B corresponds to the exemplary embodiment of FIG. 1 so that reference is made to the explanations regarding the exemplary embodiment of FIGS. 2A and 2B.

In the exemplary embodiment of FIGS. 3A and 3B, the cross section of the through-bores 37 emanating from the second face 40 in the direction of the first face 39 of the second component 32 also expands step-like, wherein however the second portion 37b of the through-bores 37 adjacent to the first face 39 in FIGS. 3A and 3B is not formed circular in the cross section but rather as an oval or elongated hole-like cross-sectional area. This follows in particular from the section B-B of FIG. 3A, from which the elongated hole-like configuration of the portion 37b of the shown through-bore 37 can be seen. On or adjacent to the second face 40 of the second component 32, the portion 37a of the respective through-bore 37 in turn has a circular cross section.

In contrast with FIGS. 2A and 2B, the two portions 37a, 37b of the respective through-bore 37 are arranged centrically to one another in FIGS. 3A and 3B, longitudinal centre axes of the portions 37a, 37b therefore coincide. Deviating from the exemplary embodiment shown in FIGS. 3A and 3B it is also possible that the two portions 37a, 37b, i.e. the portion 37a that is circular in the cross section and the portion 37b that is elongated hole-like in the cross section, are positioned eccentrically to one another.

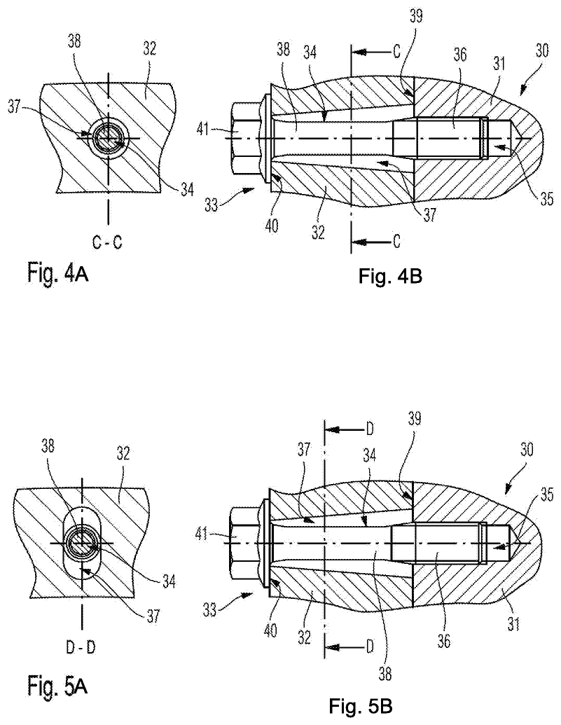

Thus while the exemplary embodiments of FIGS. 2A, 2B, 3A, and 3B each show configurations of the through-bores 37 in which the cross-sectional area of the through-bores 37 of the second housing part 32 emanating from the second face 40 increases in size step-like in the direction of the first face 39, FIGS. 4A, 4b, 5A, and 5B each show extracts from turbo machines according to the invention in the region of a housing 30, in which the through-bores 37 of the respective second housing part 32 are formed in such a manner that the cross-sectional area of the through-bores 37 of the second housing part 32 emanating from the second face 40 of the same continuously increases in size in the direction of the first face 39 of the same and thus in the direction of the respective first housing part 31, namely funnel-like or truncated cone-like.

Here it is provided in the exemplary embodiment of FIGS. 4A and 4B that the through-bore 37, which continuously expands with regard to its cross-sectional area, has a circular cross section over its entire extension, i.e. both on and adjacent to the second face 40 as well as on or adjacent to the first face 39, whereas in FIGS. 5A and 5B the through-bore 37 has a circular cross-sectional area merely on or adjacent to the second face 40, but in the region of or adjacent to the first face 39 and between these two faces, is contoured oval or elongated hole-like in the cross section in each case.

Based on a longitudinal centre axis of the through-bore 37, the continuous cross-sectional enlargement can be embodied symmetrically or even unsymmetrically.

The connecting screws 34 of the flange connections 33 of the exemplary embodiments of FIGS. 2A and 2B to 4A and 4B can be screws with a shank, in particular with a waisted shank, stud screws, or the like.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A turbo machine, comprising:
a housing comprising:
a first housing part comprises threaded bores for connecting screws; and
a second housing part comprises through-bores for the connecting screws;
wherein the first housing part and the second housing part are connected to one another via a flange connection;
wherein the second housing part lies against the first housing part with a first face and wherein screw heads of the connecting screws lie against a second face opposite the first face of the second housing part;
wherein a cross-sectional area of the through-bores of the second housing part on and adjacent to the second face have a smaller cross-sectional area than the through-bores of the second housing part on and adjacent to the first face; and
an impeller received in the housing.

2. The turbo machine according to claim 1, wherein the cross-sectional area of the through-bores of the second housing part continuously increases in size from the second face in a direction of the first face, at least in portions.

3. The turbo machine according to claim 2, wherein the cross-sectional area of the through-bores increases in size funnel-like or truncated cone-like.

4. The turbo machine according to claim 1, wherein the cross-sectional area of the through-bores of the second housing part increases in size step-like from the second face in a direction of the first face.

5. The turbo machine according to claim 1, wherein the through-bores of the second housing part on and adjacent to the second face have a circular cross-sectional area.

6. The turbo machine according to claim 1, wherein the through-bores of the second housing part on and adjacent to the first face have a circular cross-sectional area.

7. The turbo machine according to claim 1, wherein the through-bores of the second housing part on and adjacent to the first face have an oval or elongated hole-like cross-sectional area.

8. The turbo machine according to claim 1, wherein first portions of the through-bores of the second housing part on and adjacent to the second face run centrically to second portions of the through-bores of the second housing part on and adjacent to the first face.

9. The turbo machine according to claim 1, wherein first portions of the through-bores of the second housing part on and adjacent to the second face run eccentrically to second portions of the through-bores of the second housing part on and adjacent to the first face.
